(19) United States
(12) Patent Application Publication
(10) Pub. No.: US 2005/0210494 A1
(43) Pub. Date: Sep. 22, 2005

(54) Disc cartridge

(75) Inventor: Kengo Oishi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/081,569

(22) Filed: Mar. 17, 2005

(30) Foreign Application Priority Data
Mar. 19, 2004 (JP) 2004-80579

(51) Int. Cl. G11B 23/03

(52) U.S. Cl. 720/725; 360/129

(57) ABSTRACT

A disc cartridge includes a disc medium and a case to which are adhered ID labels in which ID data are described. The ID labels are configured so that the ID data of the disc medium and the ID data of the case match, and so that the disc medium and the case can be corresponded to each other on a one-to-one basis.

### CROSS-REFERENCE TO RELATED APPLICATION

This application claims priority under 35 USC 119 from Japanese Patent Application No. 2004-080579, the disclosure of which is incorporated by reference herein.

### BACKGROUND OF THE INVENTION

1. Technical Field

The present invention relates to a disc cartridge that is loaded into a drive device and houses a disc medium onto which information is recorded and from which information is played back.

2. Description of the Related Art

When information is to be recorded onto or played back from a disc medium such as an optical disc or a magneto-optical disc, the disc medium is rotated in a state in which it has been loaded into a drive device, a recording head irradiates a recording layer of the disc medium with laser light or both laser light and a magnetic field, information is recorded by pit formation resulting from decomposition and/or a rise in the temperature of the recording layer, or by phase changing or magnetization inversion, and the recorded information is played back by reading the reflectance ratio of the laser light or the difference in the polarization angle with a playback head.

For example, Japanese Patent Application Laid-Open Publication (JP-A) No. 2003-242740 proposes a disc cartridge where a label surface of the disc medium is exposed, rattling of the disc medium is eliminated in a state where the disc medium is housed, and dust is prevented from adhering to the disc medium.

In this disc cartridge, the disc medium is removably housed with respect to a case. In the instance of a DVD-ROM (a DVD dedicated to playback), playback of the information recorded on the disc medium is enabled in a state where a common user owning a simple playback device has removed the disc medium from the case.

In an instance where the disc medium is a recordable medium, such as a DVD−R (a DVD that is recordable only once) or a DVD-RW (a rewritable DVD), a user (a professional or heavy user) owning a specific recording device records information onto the disc medium in a state where the disc medium is housed in the case, and a common user plays back the disc medium. For example, with respect to the growth record of children, there are instances where additional recording is conducted by a professional, and in this instance the disc medium goes back and forth between the professional and the common user.

When the user using the disc medium changes in this manner, it is undesirable, from the standpoint of improving reliability (recording quality) at the time of recording, for the disc medium to be directly handled; rather, it is preferable for the disc medium to be handled in a state where the disc medium is housed in the case.

However, because the specifications are also slightly different depending on the case, it is also conceivable for quality maintenance to become difficult, such as the recording/playback history of the disc medium being lost, when the disc medium is housed and handled in a case other than the case in which the disc medium had been housed.

### SUMMARY OF THE INVENTION

In consideration of the above facts, a disc cartridge that can recognize the fact that the disc medium and the case match is desirable.

A first aspect of the invention provides a disc cartridge including: a disc medium that is loaded into a drive device and to and from which information can be recorded and played back; a case that rotatably houses the disc medium and into and from which the disc medium can be put and taken out; and identification means for determining whether or not the disc medium and the case correspond to each other.

The invention is configured so that the disc medium, onto which information is recorded and from which information is played back, can be put into and taken out from the case. Here, the disc medium that is recorded and played back includes disc media dedicated to playback (e.g., DVD-ROM, etc.), disc media that are recordable only once (e.g., DVD−R, DVD+R, etc.), and rewritable disc media (e.g., DVD-RW, DVD-ROM, etc.).

By disposing identification means with which it is possible to identify to determine whether or not the disc medium and the case correspond to each other, the disc medium can be housed inside the case corresponding to that disc medium, without mistakenly housing the temporarily removed disk medium inside a different case. Thus, the quality of the recording/playback history of the disc medium housed inside the case can be maintained.

### BRIEF DESCRIPTION OF THE DRAWINGS

FIG. 1 is a schematic plan view showing the exterior of a disc cartridge pertaining to an embodiment of the invention;

FIG. 2 is a perspective view, in a state where a disc medium is excluded, of the disc cartridge pertaining to the embodiment of the invention;

FIG. 3 is an exploded perspective view showing the configuration of the disc cartridge pertaining to the embodiment of the invention;

FIG. 4 is a cross-sectional view showing the configuration of the disc medium;

FIG. 5 is an exploded perspective view showing the configuration of a disc holder of the disc cartridge pertaining to the embodiment of the invention;

FIGS. 6A to 6D are descriptive views describing the operation of a disc receiver disposed in the disc cartridge pertaining to the embodiment of the invention;

FIGS. 7A to 7C are descriptive views describing the operation of the disc holder disposed in the disc cartridge pertaining to the embodiment of the invention;

FIG. 8 is a descriptive view describing the operation of a first shutter member and a second shutter member configuring the disc cartridge pertaining to the embodiment of the invention;

FIG. 9 is a descriptive view describing the operation of the first shutter member and the second shutter member configuring the disc cartridge pertaining to the embodiment of the invention;

FIG. 10 is a descriptive view describing the operation of the first shutter member and the second shutter member configuring the disc cartridge pertaining to the embodiment of the invention;

FIG. 11 is a descriptive view describing the operation of the first shutter member and the second shutter member configuring the disc cartridge pertaining to the embodiment of the invention;

FIG. 12 is a descriptive view describing the operation of the first shutter member and the second shutter member configuring the disc cartridge pertaining to the embodiment of the invention;

FIG. 13 is a descriptive view describing the operation of the first shutter member and the second shutter member configuring the disc cartridge pertaining to the embodiment of the invention; and

FIG. 14 is a schematic plan view showing a modified example of the disc cartridge pertaining to the embodiment of the invention.

### DETAILED DESCRIPTION OF THE INVENTION

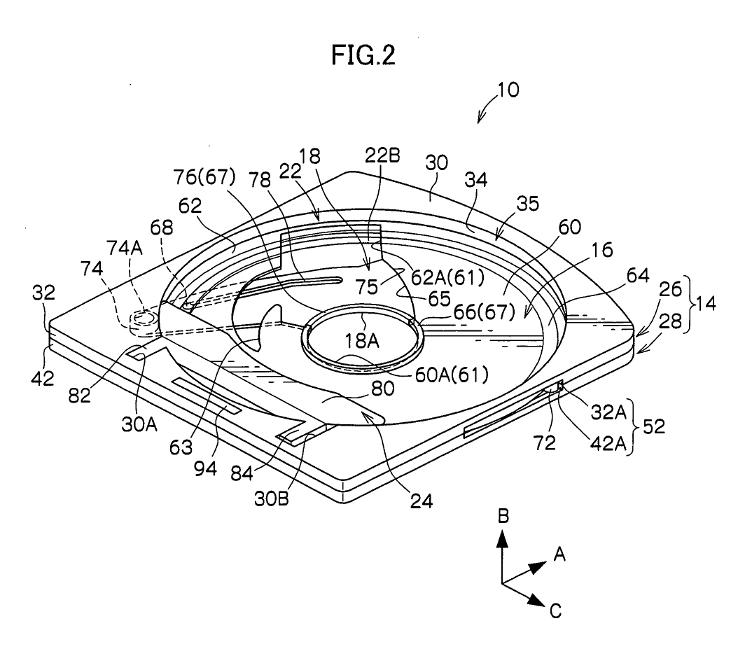

An embodiment of the invention will be described in detail below on the basis of an example shown in the drawings. With respect to FIG. 2, arrow A represents the direction in which a disc cartridge 10 is loaded into a disc drive device (referred to below simply as “drive device”), and for convenience of explanation, the side represented by arrow A will be a front side. The direction represented by arrow B, which is orthogonal to arrow A, will be an upper side, and the direction represented by arrow C, which is orthogonal to arrow A and arrow B, will be a right side. Below, there are instances where “time of storage” will be described as “when the disc cartridge 10 is not in use” and where “time of operation” will be described as “when the disc cartridge 10 is in use”.

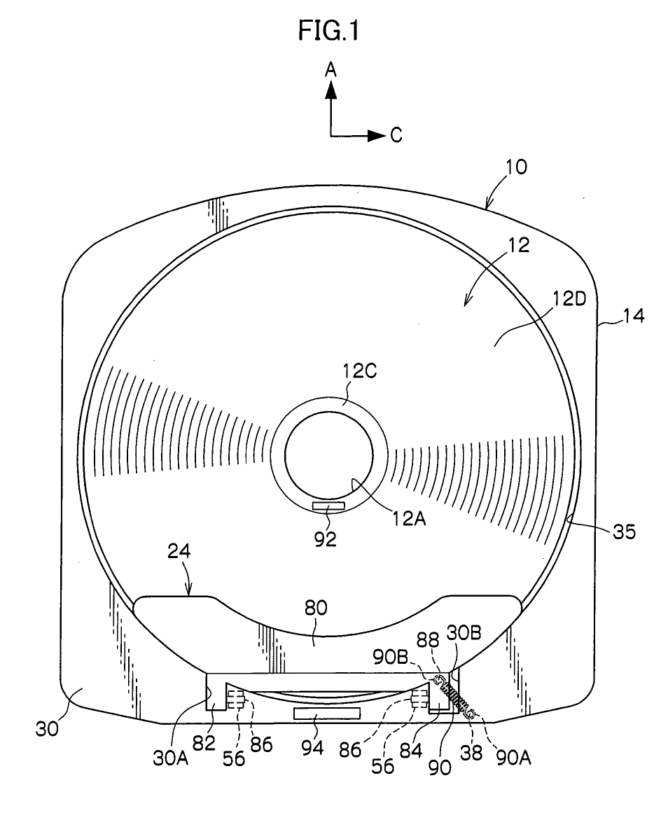

As shown in FIGS. 1 to 3, the disc cartridge 10 is mainly configured by a disc medium 12 serving as an information recording/playback medium formed in a disc shape; a case 14 that houses the disc medium 12; an inner rotor 16 and a second shutter member 18 that can open and close an opening 20 disposed in a lower surface of the case 14 in order to access the disc medium 12; a disc receiver 22 that moves up and down in association with the rotation of the inner rotor 16; and a disc holder 24 that retains the disc medium 12 at the time of storage so that the disc medium 12 does not fall out of a disc open portion 35 disposed in an upper surface of the case 14.

A lock member that deters the rotation of the inner rotor 16 and maintains the closed state of the opening 20 when the disc cartridge 10 is not in use (when the disc medium 12 is stored) is also disposed, but illustration and description thereof will be omitted.

First, the disc medium 12 will be described.

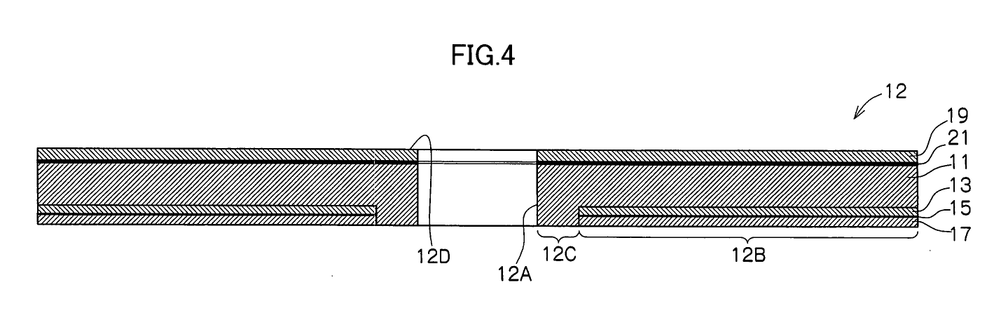

As shown in FIG. 4, the disc medium 12 is configured by a substrate 11, a reflective layer 13 that improves the reflectance ratio at the time information is played back, a recording layer 15 in which information is recorded, and a light-transmitting layer 17 that allows laser light to be transmitted therethrough. A printing layer 19 is disposed on the surface of the substrate 11.

By printing the contents of the disc medium 12, for example, on the printing layer 19, the user can easily grasp the contents of the disc medium 12. Moreover, by improving the design of the printing layer 19, the design of the disc cartridge 10 can be improved overall.

A moisture-proof layer (aluminum sputter, etc.) 21 is disposed between the printing layer 19 and the substrate 11. As described later, the substrate 11 is ordinarily exposed to the outside through the disc open portion 35. By disposing the moisture-proof layer 21 between the printing layer 10 and the substrate 11, the substrate 11 can be prevented from absorbing moisture.

An annular center hole 12A is punched in the axial center portion of the disc medium 12. The region between the center hole 12A and a recording surface 12B (region of the light-transmitting layer 17 facing the recording layer 15) serves as a chucking area 12C for a rotating spindle shaft of the drive device to retain the disc medium 12. In the present example, the diameter (outer diameter) of the disc medium 12 is substantially 120 mm.

An ID label 92, which serves as identification means, is adhered to a non-recording surface 12D side (so-called printing surface side) in the chucking area 12C. Identification data such as an ID number including information such as the manufacturing history are recorded in the ID label 92 (ID mark). For instance, the ID number may be a sequential number, so that one disc medium 12 corresponds to one number. Because it suffices as long as identification data with which information such as the manufacturing history can be identified are recorded in the ID label 92, the identification data are not limited to numbers. For instance, the identification data may also be symbols, bar codes, characters, or any combination of these.

Next, the case 14 will be described.

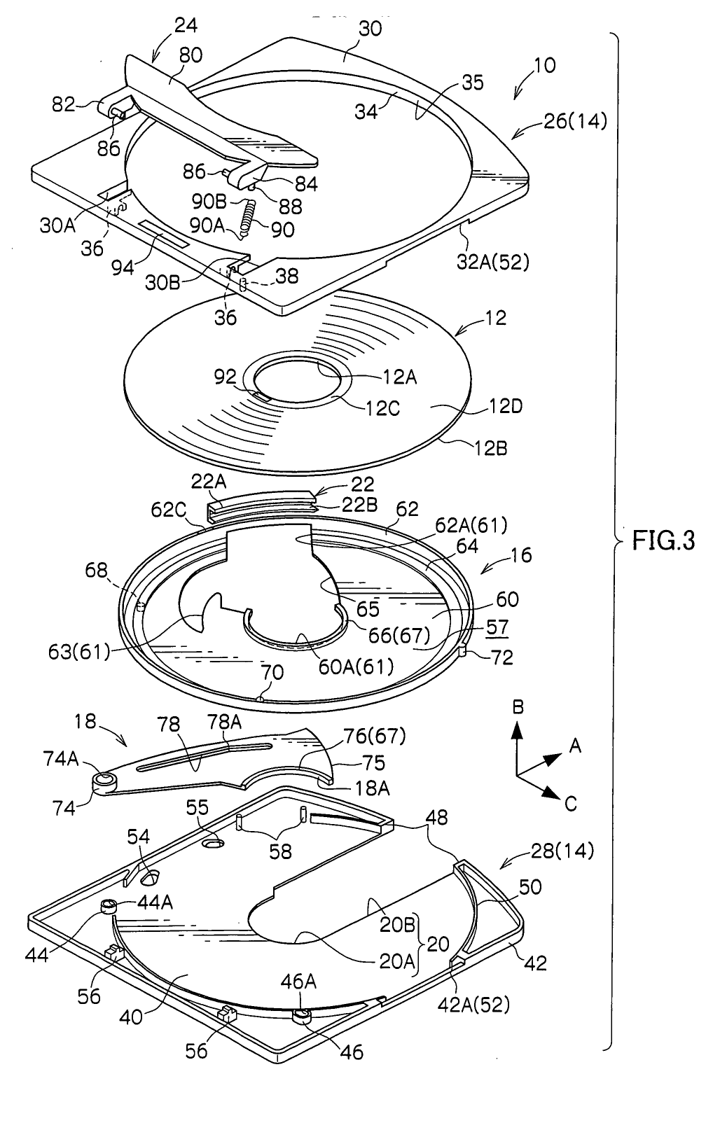

As shown in FIGS. 2 and 3, the case 14 is configured in a substantially rectangular planiform vessel shape comprising an upper shell 26 and a lower shell 28 that are made of synthetic resin and joined together. Specifically, in plan view, a front edge portion of the case 14 is formed in an arced shape that is substantially symmetrical at the left and right, and both rear end corner portions are formed in diagonally cut-out shapes. Due to this shape, the disc cartridge 10 is prevented from being improperly loaded into the drive device.

The upper shell 26 is disposed with a top plate 30, which has a shape corresponding to the shape of the case 14 in plan view, and an outer peripheral wall 32 that projects downward along an outer peripheral edge portion of the top plate 30. A substantially rectangular cutout portion 32A is formed in the right wall of the outer peripheral wall 32.

The disc open portion 35, which is formed as an annular hole with a diameter that is slightly larger than the outer diameter of the disc medium 12 (i.e., the disc open portion 35 has a size such that the disc medium 12 does not contact the disc open portion 35 even when the disc medium 12 rotates), is punched in the top plate 30. In this manner, because a portion that is exposed upward is not formed as a result of the disc open portion 35 being disposed in the top plate 30 of the upper shell 26, there is the advantage that the case 14 can be configured more thinly than a case of a closed disc cartridge in which the disc open portion 35 is not formed.

An inner peripheral wall 34 of a predetermined height is disposed, facing downward, at an inner peripheral edge portion of the disc open portion 35. The disc medium 12 is rotatably housed within the inner peripheral wall 34. Due to the disc open portion 35, insertion of the disc medium 12 into the case 14 and removal of the disc medium 12 from the case 14 are possible.

An ID label 94 serving as identification means is adhered to an upper surface rear portion side of the top plate 30. Identification data such as an ID number including information such as the manufacturing history are recorded in the ID label 94 (ID mark). For example, the ID number may be the same number as that of the disc medium 12, so that one case 14 corresponds to one disc medium 12.

Moreover, cutout portions 30A and 30B that allow arm portions 82 and 84 of the disc holder 24 are formed in the rear portion side of the top plate 30. A lock pin 38, which locks a substantially annular hook 90A formed at one end of a later-described coil spring 90 serving as urging means, is disposed further rearward than the (right-side) cutout portion 30B and at an inner surface of the outer top plate 30.

Here, the lock pin 38 side of the cutout portion 30B is cut out more widely than the cutout portion 30A, so that the cutout portion 30B allows movement of the coil spring 90 when the later-described disc holder 24 rotates to a position at which the disc medium 12 is removable.

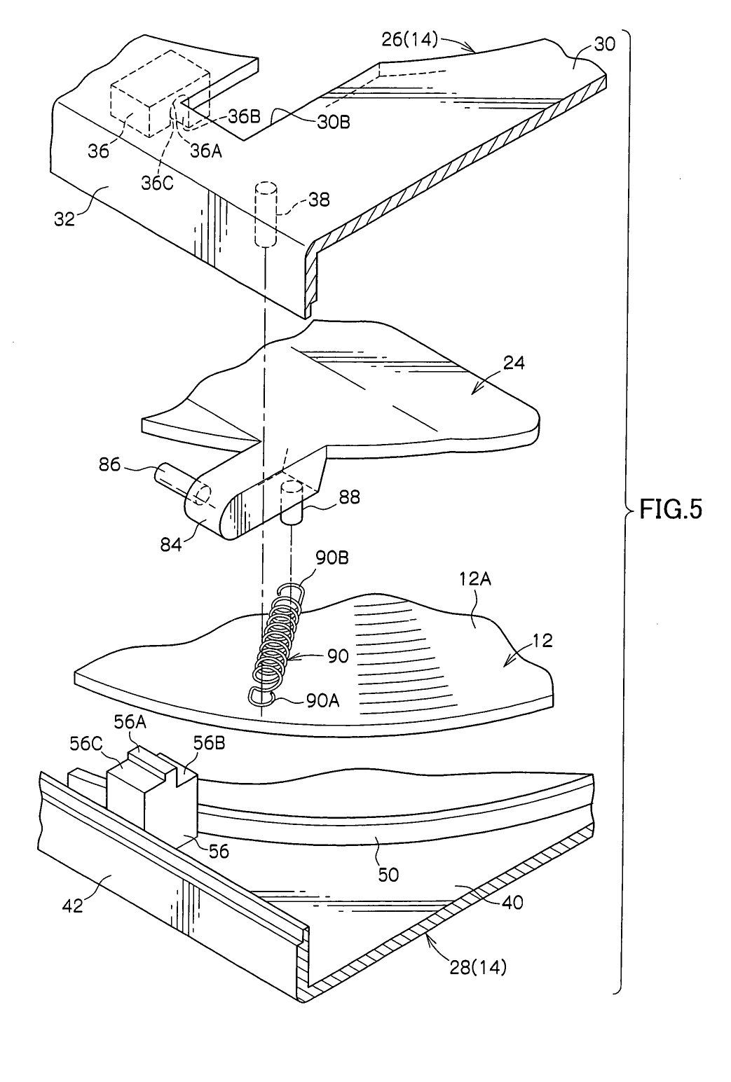

As shown in FIGS. 3 and 5, shaft holders 36 that form pairs with and rotatably retain shaft receivers 56 disposed in the lower shell 28 are disposed, with a predetermined interval therebetween, at rear portion side inner surfaces of the top plate 30 and between the cutout portions 30A and 30B so that shaft portions 86 disposed at the arm portions 82 and 84 do not come out (described later).

The lower shell 28 is disposed with a bottom plate 40, which has a shape substantially corresponding to that of the top plate 30, and an outer peripheral wall 42, which has a shape corresponding to the outer peripheral wall 32 of the upper shell 26. An opening 20 is disposed in the bottom plate 40. The opening 20 is configured by a substantially circular hub hole 20A, which has a diameter that is larger than the outer diameter of the center hole 12A of the disc medium 12 and slightly smaller than the outer diameter of the chucking area 12C (inner diameter of the recording surface 12B), and a substantially rectangular recording/playback head-use window portion 20B that is continuously disposed further frontward than a centerline along the left-right direction of the hub hole 20A. Overall, the opening 20 is formed in a substantial “U” shape that opens frontward. The hub hole 20A and the recording/playback head-use window portion 20B are not limited to these shapes, and they may also be independently disposed.

In any event, the hub hole 20A is disposed so as to be coaxial with the housed disc medium 12 in a state where the upper shell 26 and the lower shell 28 are joined together. Additionally, because the hub hole 20A has the aforementioned dimension, when the disc cartridge 10 is not in use, only the center hole 12A and the chucking area 12C are exposed to the outside, and the recording surface 12B is not exposed to the outside. Also, the recording/playback head-use window portion 20B for exposing the recording surface 12B is widened so that the left edge thereof is positioned further leftward than a tangential line along the front-rear direction of the hub hole 20A, and the front portion of the recording/playback head-use window portion 20B opens frontward with the outer peripheral wall 42 being cut out.

The rotating spindle shaft of the drive device is configured to be insertable into the hub hole 20A to rotatingly drive the disc medium 12 while engaging with and retaining the center hole 12A of the disc medium 12 through the hub hole 20A. A recording/playback head of the drive device enters the recording/playback head-use window portion 20B and records or plays back information with respect to the recording layer 15 (see FIG. 4) of the disc medium 12. In this instance, because the recording/playback head-use window portion 20B also opens frontward, the recording/playback head can easily access the disc medium 12 as far as the outer peripheral edge portion of the recording surface 12B.

A pair of bosses 44 and 46 are disposed, with a predetermined interval therebetween, at the rear portion side inner surface of the bottom plate 40. The left-side boss 44 is formed in a circular shape when seen in plan view, and the right-side boss 46 is formed in an elliptic shape that is long in the left-right direction when seen in plan view. Positioning holes 44A and 46A are disposed in the bosses 44 and 46. Positioning pins (not shown) of the drive device are inserted into the positioning holes 44A and 46A, whereby the disc cartridge 10 is positioned inside the drive device.

A rib-like inner wall 50 that houses and rotatably retains the later-described inner rotor 16 inside is vertically disposed on the bottom plate 40. The inner wall 50 is formed in a discontinuous arced shape when seen in plan view and has a diameter that is slightly larger than that of the inner rotor 16. Dust-proof ribs 48 are vertically disposed at front ends of both left and right edge portions of the recording/playback head-use window portion 20B. Front ends of the dust-proof ribs 48 are continuous with the outer peripheral wall 42, and rear ends of the dust-proof ribs 48 are continuous with the inner wall 50. The height of the dust-proof ribs 48 and the inner wall 50 is equal to the height of an annular wall portion 62 of the inner rotor 16.

A substantially rectangular cutout portion 42A corresponding to the cutout portion 32A formed in the outer peripheral wall 32 of the upper shell 26 is formed in the right-side outer peripheral wall 42. When the case 14 is formed by joining together the upper shell 26 and the lower shell 28 with screws or by ultrasonic welding in a state where the end surfaces of the outer peripheral walls 32 and 42 abut against each other, a shutter operation window 52 is formed through which an operational protrusion 72 of the inner rotor 16 protrudes.

The shutter operation window 52 is not limited to being disposed in the right wall side of the case 14. The position at which the shutter operation window 52 is disposed may be appropriately changed depending on the relation with the drive device and the shapes of the inner rotor 16 and the second shutter member 18.

The shaft receivers 56, which form pairs with the shaft holders 36 disposed in the upper shell 26 and rotatably support the shaft portions 86 of the later-described disc holder 24, are disposed, with a predetermined interval therebetween, at the rear portion side inner surface of the bottom plate 40. Each shaft receiver 56 includes a protruding ridge portion 56A, which has a predetermined height and is parallel to the shaft portions 86, and step portions 56B and 56C, which are formed in front of and behind the protruding ridge portion 56A. The step portions 56B and 56C are formed such that the front-side step portion 56B is low and the rear-side step portion 56C is high.

Each of the shaft holders 36 formed in the upper shell 26 includes a bottom portion 36A, which is formed in a semicircular arced shape when seen in side view, and a front wall portion 36B and a rear wall portion 36C, which continue from the bottom portion 36A and are linearly formed. Each shaft holder 36 is formed such that the height of the front wall portion 36B and the height of the rear wall portion 36C are different: e.g., such that the front wall portion 36B is higher than the rear wall portion 36C.

Each of the shaft holders 56 is configured to be insertable between the front wall portion 36B and the rear wall portion 36C of the shaft holder 36. When the shaft holders 36 are caused to face the shaft receivers 56, and the end surfaces of the front wall portions 36B are caused to abut against the step portions 56B, and the end surfaces of the rear end portions 36C are caused to abut against the step portions 56C (i.e., when the case 14 is assembled by covering the lower shell 28 with the upper shell 26), spaces in which the shaft portions 86 of the disc holder 24 can be rotatably retained are formed between the bottom portions 36A and the protruding ridge portions 56A.

Concave portions 54 and 55, with which an engagement protrusion 68 disposed at the undersurface of the inner rotor 16 engages, are formed, with a predetermined interval therebetween, in the inner surface of the bottom plate 40. The concave portions 54 and 55 are formed so that their mutually opposing sides are gradual inclined surfaces. A pair of guide pins 58, which support the disc receiver 22 so that the disc receiver 22 can move up and down with respect to the bottom plate 40, are disposed, with a predetermined interval therebetween, on the inner surface of the bottom plate 40 in front of the concave portions 54 and 55.

Next, the inner rotor 16 and the second shutter member 18 will be described.

As shown in FIG. 3, the inner rotor 16 and the second shutter member 18 are disposed on the bottom plate 40 of the lower shell 28. The inner rotor 16 is disposed coaxially with the disc medium 12, and the second shutter member 18 is disposed so as to be rotatable around a different axis from that of the inner rotor 16.

The recording/playback head-use window portion 20B opens and closes due to the inner rotor 16 and the second shutter member 18 rotating in mutually opposite directions. When the recording/playback head-use window portion 20B is open, part of the recording surface 12B of the disc medium 12 is exposed to the outside, so that the recording/playback head of the drive device can access the recording surface 12B.

Together with the inner peripheral wall 34 of the disc open portion 35 of the upper shell 26, the inner rotor 16 configures a housing portion 57 that can house the disc medium 12. The inner rotor 16 is configured by a first shutter 60, which faces the recording surface 12B of the disc medium 12 with a predetermined gap between the first shutter 60 and the recording surface 12B, and the annular wall portion 62 that enables the disc medium 12 to be housed thereinside.

When the case 14 has been assembled, the annular wall portion 62 is positioned inside the inner wall 50 of the lower shell 28 and rotatably disposed outside the inner peripheral wall 34 of the upper shell 26, so that the upper end of the annular wall portion 62 is covered by the upper shell 26 (top plate 30).

At the inner surface of the first shutter 60, an outer periphery receiving portion 64, which protrudes upward, is disposed along the annular wall portion 62 so as to support the outer peripheral edge portion of the disc medium 12 from below. An open portion 61 is formed in the first shutter 60.

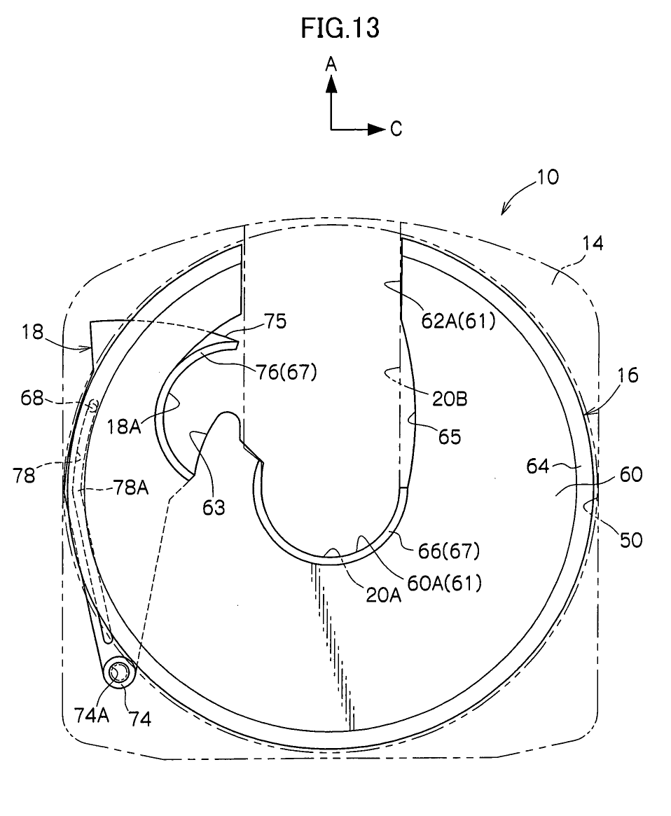

The open portion 61 is disposed with a cutout portion 60A, which has an arced shape when seen in plan view and corresponds to the hub hole 20A of the lower shell 28, and a cutout portion 62A, which is cut out in a substantially rectangular shape including the outer periphery receiving portion 64 at a predetermined position of the annular wall portion 62, i.e., at the portion corresponding to the recording/playback head-use window portion 20B at the time the opening 20 is open (see FIG. 13). An inner periphery receiving portion 66, which has an arced shape when seen in plan view and supports the outer peripheral edge portion of the chucking area 12C of the disc medium 12, is disposed at an inner peripheral edge portion of the cutout portion 60A.

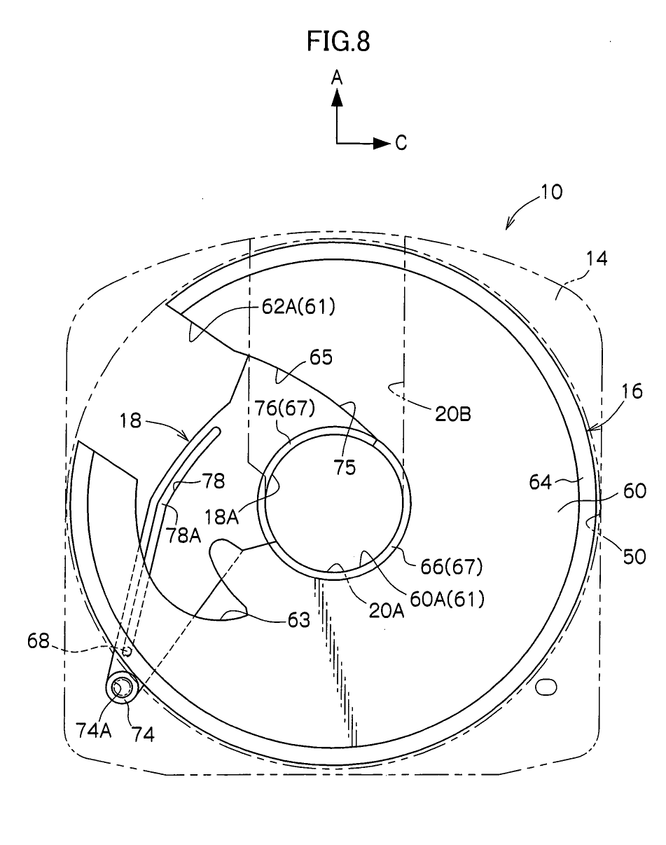

An abutment portion 65 is disposed between the cutout portion 60A and the cutout portion 62A positioned at the right side of the open portion 61. The abutment portion 65 has an arced shape when seen in plan view and opens further outward than the right end edge of the recording/playback head-use window portion 20B at the time the recording/playback head-use window portion 20B is open (see FIG. 13). The abutment portion 65 abuts against the second shutter member 18 in a state where the recording/playback head-use window portion 20B is closed (see FIG. 8).

A cutout portion 63 that communicates with the cutout portion 60A is formed in the left side of the open portion 61 (described later). The engagement protrusion 68 for causing the second shutter member 18 to move in association with the inner rotor 16 is disposed at a predetermined position on the undersurface of the outer periphery receiving portion 64 at the cutout portion 63 side (described later).

A convex portion 70 for lifting up the disk holder 24 to a predetermined height is disposed at a predetermined position on the upper surface of the annular wall portion 62. The operational protrusion 72 that protrudes from the shutter operation window 52 is disposed, so as to project in the radial direction, at a predetermined position on the outer peripheral surface of the annular wall portion 62. A cam step portion 62C that engages with the later-described disc receiver 22 is formed at a predetermined position on the upper surface of the annular wall portion 62 leftward of the cutout portion 62A.

The second shutter member 18 includes a boss 74 including a hole portion 74A that fits around the outer periphery of the boss 44 disposed at the left side of the lower shell 28. The second shutter member 18 is configured to be rotatable around the boss 40. In other words, the boss 44 serves as the rotational fulcrum of the second shutter member 18. The end surface of the second shutter member 18 at the opposite side from the boss 74 serves as an abutment surface 75 that has an arced shape when seen in plan view and planarly contacts the abutment portion 65 of the inner rotor 16.

A cutout portion 18A, which has an arced shape when seen in plan view and corresponds to the hub hole 20A, is formed in the second shutter member 18. An inner periphery receiving portion 76 is disposed at an inner peripheral edge portion of the cutout portion 18A. The inner periphery receiving portion 76 has an arced shape when seen in plan view and configures an annular convex portion 67 with a predetermined height by abutting against the side surface of the inner periphery receiving portion 66 of the inner rotor 16 at the time the recording/playback head-use window portion 20B is closed (see FIG. 8).

In this manner, the inner peripheral edge portion of the disc medium 12 is supported from below by the inner periphery receiving portions 66 and 76 configuring the annular convex portion 67. Namely, at the time the recording/playback head-use window portion 20B is closed, the inner periphery receiving portions 66 and 76 abut against the outer peripheral edge of the chucking area 12C of the disc medium 12, and the outer periphery receiving portion 64 abuts against the outer peripheral edge portion of the disc medium 12, whereby dust and moisture are prevented from reaching the recording surface 12B through the hub hole 20A at the time the recording/playback head-use window portion 20B is closed.

A long and narrow guide hole 78, which has a substantial “V” shape when seen in plan view, is disposed at a predetermined position in the second shutter member 18. The engagement protrusion 68 of the inner rotor 16 is inserted into and engages with the guide hole 78, whereby the second shutter member 18 is movable in mutually opposite directions in cooperation with the inner rotor 16.

It should be noted that the cutout portion 63 is formed in the first shutter 60 of the inner rotor 16 to match the movement locus of the inner periphery receiving portion 76 because the upper surface of the inner periphery receiving portion 76 protrudes more than the inner surface of the first shutter 60 of the inner rotor 16. Also, the engagement protrusion 68 is configured to go through the guide hole 78 and be inserted in the concave portions 54 and 55. In other words, the protruding height of the engagement protrusion 68 is higher than the plate thickness of the second shutter member 18.

Next, the disc receiver 22 will be described.

As shown in FIG. 3, the disc receiver 22 is for compensating for the fact that part of the outer periphery receiving portion 64 is eliminated as a result of the cutout portion 62A being formed, and forms a bridge so as to close the cutout portion 62A at the time the recording/playback head-use window portion 20B is closed. Specifically, the disc receiver 22 is formed in a substantial “U” shape when seen in cross section that can house the annular wall portion 62 therein, and is formed so that it has an arced shape whose curvature is the same as that of the annular wall portion 62 when seen in plan view.

A pair of engagement grooves (not shown), with which the guide pins 58 disposed on the lower shell 28 engage, are formed in both end portions of the disc receiver 22, so that the disc receiver 22 can move up and down along the guide pins 58.

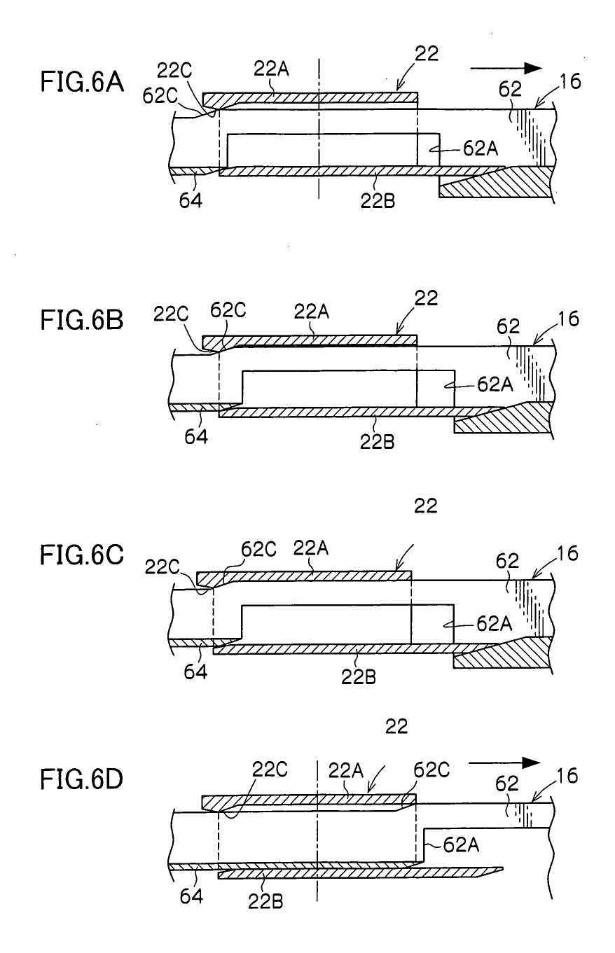

As shown in FIGS. 6A to 6B, a cam protrusion 22C that engages with the cam step portion 62C is formed at an undersurface left end portion of an upper wall 22A of the disc receiver 22 so that the disc receiver 22 moves up and down in accompaniment with the rotation of the inner rotor 16.

Thus, at the time the recording/playback head-use window portion 20B is closed (see FIG. 6A), the disc receiver 22 is at a risen position and closes off the cutout portion 62A because the cam protrusion 22C is supported at the upper surface of the annular wall portion 62. Additionally, a lower wall 22B of the disc receiver 22 compensates for part of the missing outer periphery receiving portion 64 and supports the outer peripheral edge portion of the disc medium 12 together with the outer periphery receiving portion 64.

At the time the recording/playback head-use window portion 20B is open (see FIG. 6D), the disc receiver 22 is lowered, avoids collision with the inner rotor 16 and allows the movement (rotation) of the inner rotor 16 because the cam protrusion 22C engages with the cam step portion 62C.

An upward-facing tapered surface is formed at the left end portion of the lower wall 22B of the disc receiver 22, and a downward-facing tapered surface is formed at the end portion facing the left edge portion of the cutout portion 62A of the outer periphery receiving portion 64. Thus, the outer periphery receiving portion 64 is easily lifted up on the lower wall 22B in accompaniment with the rotation of the inner rotor 16. A downward-facing tapered surface is also formed at the right end portion of the lower wall 22B, and this tapered surface is configured to planarly contact the upward-facing tapered surface formed at the outer periphery receiving portion 64.

Next, the disc holder 24 will be described.

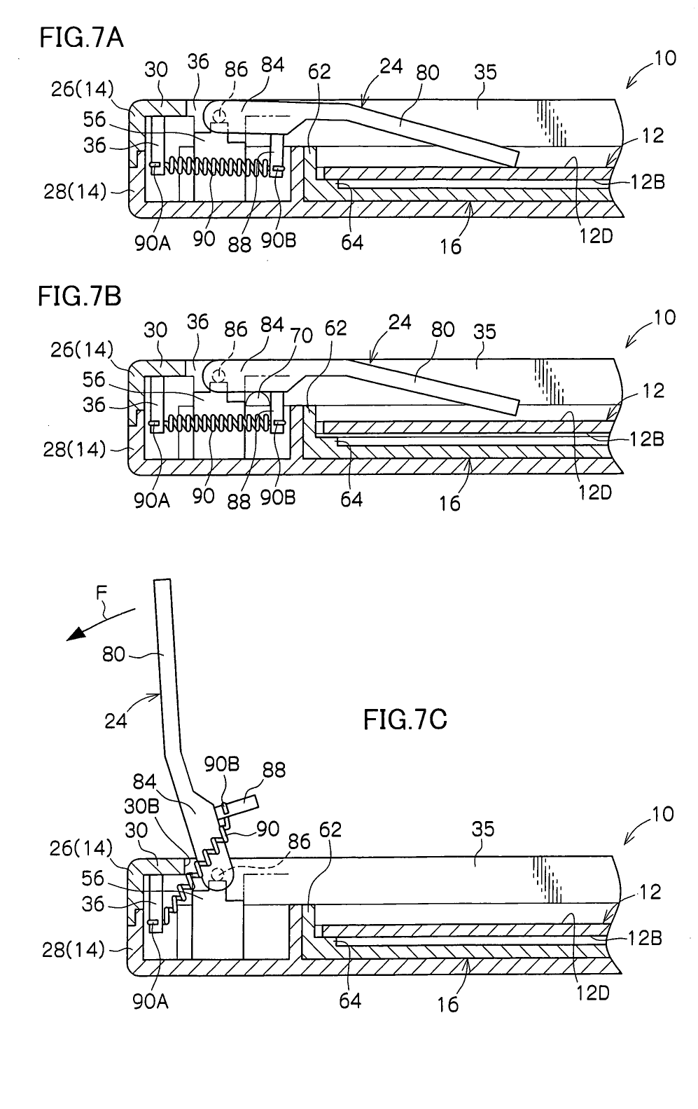

As shown in FIG. 3 and FIGS. 7A to 7C, the disc holder 24 is configured by the pair of arm portions 82 and 84 and a holder portion 80. The arm portions 82 and 84 are disposed at the rear portion side of the case 14 facing the front portion side in which the opening 20 is disposed, are rotatably supported with respect to the case 14, and are separated by a predetermined interval. The holder portion 80 is disposed continuously with ends of the arm portions 82 and 84 so as to be symmetrical at the left and right, and has a substantial crescent shape, when seen in plan view, along the shape of the disc medium 12 so as to cover part of the non-recording surface 12D of the disc medium 12.

The holder portion 80 is formed in a substantial crescent shape when seen in plan view that is symmetrical at the left and right, whereby it avoids the chucking area 12C of the disc medium 12, enters the disc open portion 35 and does not interfere with a chucking member (not shown) of the drive device retaining the chucking area 12C from above.

The end portion of the holder portion 80 holds the non-recording surface 12D of the disc medium 12, but the holder portion 80 may also be configured so that both left and right end ends are slightly curved towards the disc medium 12 to hold only the outer peripheral edge portion of the disc medium 12. In any event, due to the disc holder 24, the disc medium 12 is prevented from falling out of the disc open portion 35, and at the time the disc medium 12 is being retained, the disc medium 12 is retained inside the housing portion 57 so that the disc medium 12 does not rattle (see FIG. 7A).

The cylindrical shaft portions 86 are disposed at the rear ends of the pair of arm portions 82 and 84 so as to project inward from the left and right. The shaft portions 86 are configured so that they are rotatably inserted into the space formed between the shaft receiving portions 56 of the lower shell 28 and the shaft holders 36 of the upper shell 26.

A lock pin 88 that locks a substantially annular hook 90B formed at the other end of the coil spring 90 is disposed on the inner surface (undersurface) of the (right-side) arm portion 84. In a state where the end (hook 90A) of the coil spring 90 is locked to the lock pin 38 disposed on the inner surface of the top plate 30 and the other end (hook 90B) of the coil spring 90 is locked to the lock pin 88, the disc holder 24 is constantly urged by the coil spring 90 towards the disc medium 12.

The inner surface of the other (left-side) arm portion 82 serves as a working surface that pushes up the disc holder 24 when the convex portion 70 disposed on the upper surface of the annular wall portion 62 of the inner rotor 16 abuts against the working surface. At the time the disc medium 12 is operating (rotating), the working surface of the arm portion 82 abuts against the convex portion 70, and the disc holder 24 is retained at a slightly elevated position counter to the urging force of the coil spring 90 to allow the rotation of the disc medium 12.

Moreover, when the disc medium 12 is to be removed from the disc open portion 35, the disc holder 24 is manually rotated rearward. At this time, the urging force and attachment position of the coil spring 90 are regulated so that the disc holder 24 is temporarily retained at its maximum rotation position.

Namely, the position at which the latch pin 88 is disposed is regulated so that, when the disc holder 24 rotates and the outer surface (upper surface) of the arm portion 82 is at its maximum rotation position where it abuts against the rear end portion of the cutout portion 30B formed in the top plate 30, as shown in FIG. 7C, the coil spring 90 enters the widely formed cutout portion 30B and the urging force of the coil spring 90 crosses the shaft portion 86 in the direction of arrow F.

Due to this configuration, the disc holder 24 is temporarily retained at the maximum rotation position. Thus, the disc holder 24 is retainable in three states (orientations): a retention position at which the disc medium 12 is retained, an operating position at which the rotation of the disc medium 12 is enabled, and a removal position at which the disc medium 12 can be removed. Also, as shown in FIGS. 7A and 7B, the disc holder 24 is configured so that it does not project from the upper surface of the case 14 (top plate 30) when seen in side view at the positions other than the removal position at which the disc medium 12 is removed (particularly the operating position).

Thus, particularly with respect to the operating position, there is the effect that the drive device can be further thinned in comparison to an instance where the disc holder 24 ends up projecting from the upper surface of the case 14 (top plate 30). There is also the effect that, even in a configuration where the loading port of the drive device is vertical (the disc cartridge 10 is vertically loaded) and the disc medium 12 is rotatingly driven at that orientation, the disc medium 12 can be appropriately prevented from falling out.

The disc holder 24 may be disposed at the rear portion side of the case 14 if the disc holder 24 is required to act as a gripping member for gripping the disc cartridge 10 when the disc cartridge 10 is loaded into the drive device.

Moreover, when the case 14 is assembled by covering the lower shell 28 with the upper shell 26, the shaft portions 86 of the disc holder 24 are rotatably retained by the shaft receivers 56 and the shaft holders 36, so that it is impossible to separate the disc holder 24 from the case 14 after the case 14 has been assembled. In other words, there is the potential for the user to accidentally lose the disc holder 24 if the disc holder 24 is easily separable from the case 14 even after the case 14 has been assembled, but because it is impossible for the disc holder 24 to be separated from the case 14 as long as the case 14 is not disassembled, troubles such as losing the disc holder 24 do not occur.

In order for the user to be able to easily identify the operating function of the disc holder 24, characters, a color that is different from that of the case 14, or a pattern may also be appropriately formed at least on the upper surface of the disc holder 24. Some kind of identification means different from these may be formed on the upper surface of the disc holder 24 so that the user is able to easily identify the disc holder 24.

Next, the action of the disc cartridge 10 having the above configuration will be described.

FIGS. 8 to 13 show plan views excluding the upper shell 26 and the disc medium 12. As shown in FIG. 8, at the time the disc cartridge 10 is not in use (at the time the disc medium 12 is stored), the recording/playback head-use window portion 20B is closed by the inner rotor 16 and the second shutter member 18.

Namely, the inner rotor 16 and the second shutter member 18 are configured to close the recording/playback head-use window portion 20B when their mutual abutment portions 65 and 75 abut against each other. The abutment portions 65 and 75 may be formed as tapered surfaces so that they can be vertically superposed, whereby the ingression of dust inside the case 14 can be reliably prevented.

At this time, the side surfaces of the inner periphery receiving portions 66 and 76 abut against each other, so that the inner periphery receiving portions 66 and 76 are annularly formed. Additionally, the engagement protrusion 68 of the inner rotor 16 penetrates the rear end portion side of the guide hole 78 of the second shutter member 18 and is inserted in the concave portion 54 (see FIG. 3) of the lower shell 28.

As shown in FIG. 6A, at the time the recording/playback head-use window portion 20B is closed, the cam protrusion 22C is supported on the upper surface of the annular wall portion 62, whereby the disc receiver 22 is at an elevated position and closes the cutout portion 62A. Additionally, the lower wall 22B of the disc receiver 22 compensates for the missing part of the outer periphery receiving portion 64 and supports the outer peripheral edge portion of the disc medium 12 together with the outer periphery receiving portion 64.

Thus, as shown in FIGS. 3 and 8, at the time the recording/playback head-use window portion 20B is closed, the disc medium 12 is housed inside the housing portion 57 in a state where the chucking area 12C is supported by the inner periphery receiving portions 66 and 76 and the outer peripheral edge portion of the disc medium 12 is supported by the outer periphery receiving portion 64 and the lower wall 22B of the disc receiver 22. Thus, the recording surface 12B is completely shielded from the outside.

In other words, there are instances where dust or the like will adhere to the non-recording surface 12D side of the disc medium 12 due to the disc open portion 35 being disposed; however, when the disc cartridge 10 is not in use, the recording/playback head-use window portion 20B is closed by the inner rotor 16 and the second shutter member 18, whereby dust or the like does not adhere to the recording surface 12B side, and water or the like does not penetrate.

Also, as shown in FIGS. 1 and 7A, which also show the upper shell 26 and the disc medium 12, when the disc cartridge 10 is not in use (when the disc medium 12 is stored), the disc holder 24 holds the non-recording surface 12D side of the disc medium 12.

Namely, the left and right ends of the holder portion 80 press and retain the outer peripheral edge portion of the non-recording surface 12D side of the disc medium 12. Thus, the disc medium 12 does not fall out of the disc open portion 35 and does not rattle inside the housing portion 57.

Recording or playback is conducted by loading the disc cartridge 10 in the drive device. When the disc cartridge 10 is loaded into the loading port of the drive device, the inner rotor 16 and the second shutter member 18 rotate so that the recording/playback head-use window portion 20B is opened, and the positioning pins (not shown) are inserted into the positioning holes 44A and 46A so that the disc cartridge 10 is positioned inside the drive device.

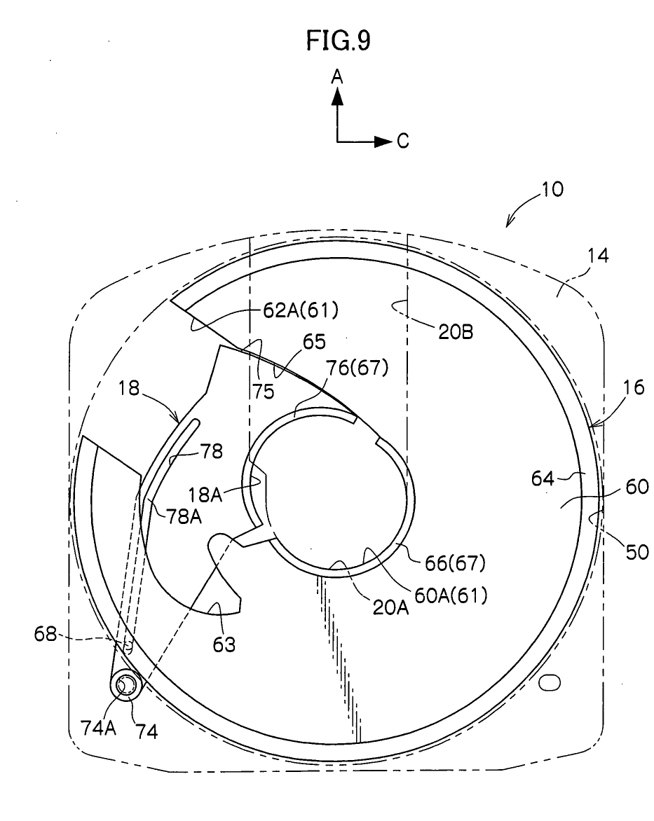

Then, as shown in FIGS. 3 and 9, an open/close member (not shown) of the drive device engages with the operational protrusion 72 protruding from the front end side of the shutter operation window 52. When the operational protrusion 72 is moved towards the rear of the case 14, the inner rotor 16 begins rotating in a clockwise direction along the inner wall 50 around the hole 20A, and the side surfaces of the abutment portions 65 and 75 and the inner periphery receiving portions 66 and 76 begin to separate from each other.

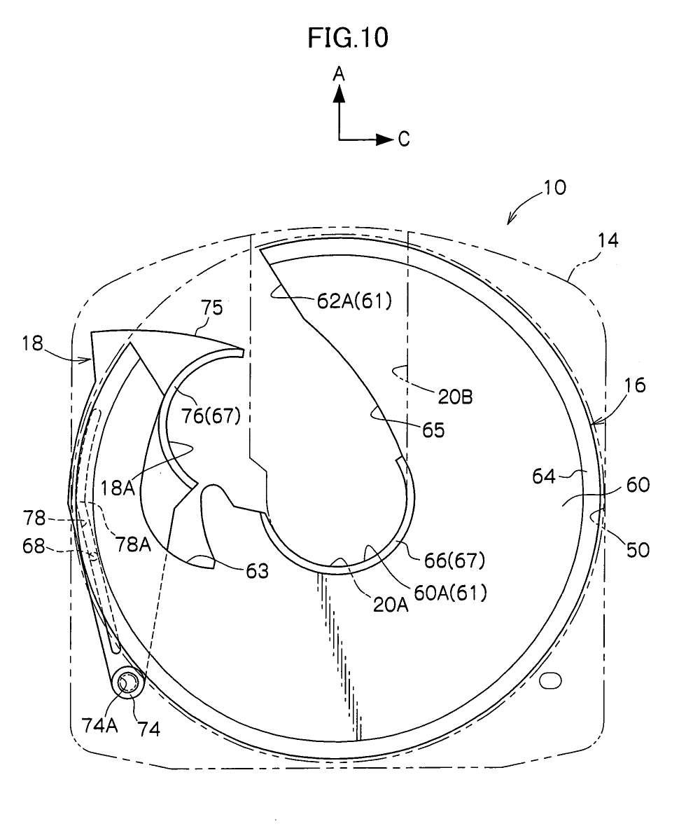

Next, as shown in FIGS. 6A to 6D, the cam protrusion 22C of the disc receiver 22 begins to engage with the cam step portion 62C of the annular wall portion 62, and the disc receiver 22 begins to fall along the guide pins 58 (see FIG. 3). At this time, as shown in FIGS. 9 and 10, the engagement protrusion 68 slides inside the guide hole 78, and the second shutter member 18 begins rotating in a counter-clockwise direction around the boss 44.

At this time, the engagement protrusion 68 smoothly escapes from the inside of the concave portion 54 because at least the sliding direction side of the concave portion 54 from which the engagement protrusion 68 leaves is formed as a gradual inclined surface, and the engagement protrusion 68 begins sliding on the bottom plate 40 of the lower shell 28. In other words, the inner periphery receiving portion 76 of the second shutter member 18 separates from the chucking area 12C in a state where the outer peripheral edge portion of the disc medium 12 is supported on the outer periphery receiving portion 64.

Here, because the engagement protrusion 68 is formed higher than the plate thickness of the second shutter member 18, at least the vicinity of the engagement protrusion 68 of the inner rotor 16 rises to a predetermined height from over the second shutter member 18 and from over the bottom plate 48 of the lower shell 28 due to the engagement protrusion 68. Thus, the second shutter member 18 is rotatable in the counter-clockwise direction without the inner periphery receiving portion 76 contacting the recording surface 12B.

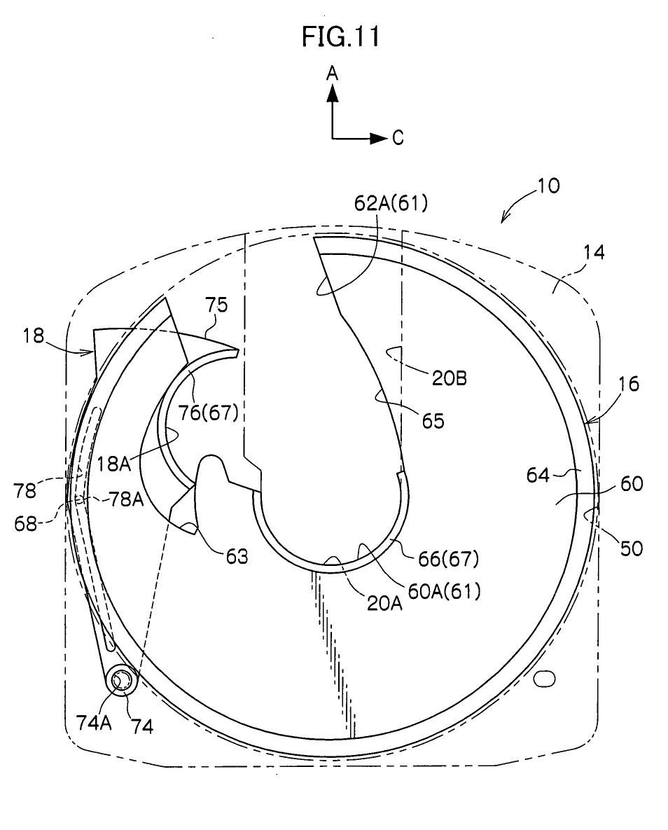

Thereafter, the inner rotor 16 further rotates in the clockwise direction, and the second shutter member 18 rotates in the counter-clockwise direction in accompaniment with the rotation of the inner rotor 16, whereby the recording/playback head-use window portion 20B begins to open. Then, as shown in FIG. 11, the second shutter member 18 stops rotating in the counter-clockwise direction at the point in time when the engagement protrusion 68 reaches the curved portion 78A formed in the guide hole 78.

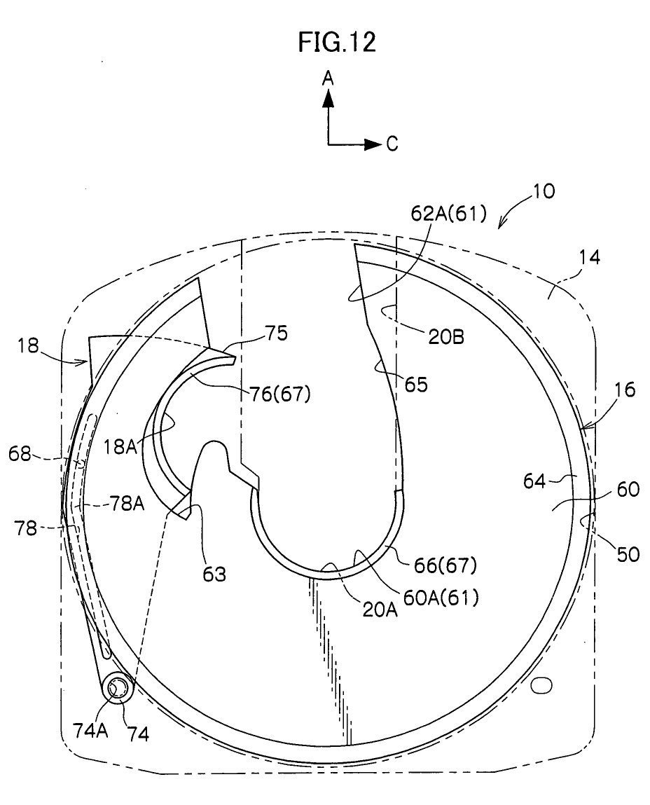

As shown in FIG. 12, the inner rotor 16 further rotates in the clockwise direction even after the rotation of the second shutter member 18 has stopped, and the engagement protrusion 68 slides inside the guide hole 78 in accompaniment with the rotation of the inner rotor 16. Then, as shown in FIG. 13, the recording/playback head-use window portion 20B is completely opened when the engagement protrusion 68 reaches the front end portion side of the guide hole 78.

At this time, the operational protrusion 72 is positioned at the rear end side of the shutter operation window 52, and the engagement protrusion 68 is inserted inside the concave portion 55 of the lower shell 28. Because at least the sliding direction side of the concave portion 55 into which the engagement protrusion 68 enters is also formed as a gradual inclined surface, the engagement protrusion 68 is smoothly inserted into the concave portion 55.

Thus, the inner rotor 16 (the first shutter 60) falls on the second shutter member 18 and on the bottom plate 40 of the lower shell 28; however, the center hole 12A and the chucking area 12C of the disc medium 12 are already retained (chucked) by the rotating spindle shaft of the drive device entering from the hub hole 20A and the chucking member entering from the disc open portion 35, and the disc medium 12 itself rises as far as the rotation allowance position (the outer peripheral edge portion of the disc medium 12 is separated from the outer periphery receiving portion 64). Thus, the recording surface 12B of the disc medium 12 does not contact the inner periphery receiving portion 76 of the second shutter member 18.

At this time, as shown in FIG. 7B, the convex portion 70 disposed on the annular wall portion 62 abuts against the working surface of the arm portion 82 of the disc holder 24, causing the arm portion 82 to rise. In other words, the disc holder 24 is caused to rise to a predetermined height, and the end of the holder portion 80 is caused to separate from the non-recording surface 12D of the disc medium 12. Thus, the disc holder 24 does not interfere with the disc medium 12.

Moreover, because the disc holder 24 is formed in a substantial crescent shape that is symmetrical in the left-right direction when seen in plan view, it does not interfere with the rotating spindle shaft. Namely, when the rotating spindle shaft chucks (retains) the center hole 12A and the chucking area 12C of the disc medium 12, the problem of the disc holder 24 hindering chucking (retention) does not arise.

In any event, when the recording/playback head-use window portion 20B has been opened and the holding (press and retention) of the disc medium 12 by the disc holder 24 has been released, the disc medium 12 is rotated by the rotating spindle shaft, and information is recorded to the recording layer 15 (see FIG. 4) or information recorded in the recording layer 15 is played back by the recording/playback head of the drive device entering through the recording/playback head-use window portion 20B.

When the disc cartridge 10 is to be removed from the drive device, first, the positioning pins are removed from the positioning holes 44A and 46A shown in FIG. 3, so that the positioning of the disc cartridge 10 inside the drive device is released. Then, movement in the direction in which the disc cartridge 10 is discharged from the loading port of the drive device begins due to a discharge mechanism or the like (not shown) of the drive device.

Then, the open/close member of the drive device causes the operational protrusion 72 protruding from the rear end side of the shutter operation window 52 to move towards the front of the case 14, and the inner rotor 16 begins rotating in the counter-clockwise direction of FIGS. 13 and 12 along the inner wall 50 around the hub hole 20A. Then, the engagement protrusion 68 that had been positioned at the front end portion side of the guide hole 78 moves toward the rear side of the case 14 along the guide hole 78 and escapes from the concave portion 55 (see FIG. 3). At this time, the engagement protrusion 68 smoothly escapes from the concave portion 55 because the sliding direction side of the concave portion 55 from which the engagement protrusion 68 leaves is formed as a gradual inclined surface.

Then, as shown in FIGS. 11 and 10, when the inner rotor 16 rotates in the counter-clockwise direction and the engagement protrusion 68 passes the curved portion 78A of the guide hole 78, the second shutter member 18 begins moving in the clockwise direction. At this time, the retention (chucking) of the disc medium 12 by the rotating spindle shaft is already released, but at least the engagement protrusion 68 vicinity of the inner rotor 16 rises to a predetermined height because the engagement protrusion 68 has escaped from the concave portion 55 and is sliding on the bottom plate 40. Thus, the inner periphery receiving portion 76 of the second shutter member 18 does not contact the recording surface 12B.

Moreover, as shown in FIG. 9, the inner rotor 16 rotates in the counterclockwise direction and the second shutter member 18 rotates in the clockwise direction, whereby the recording/playback head-use window portion 20B begins to open. In accompaniment with this rotation, as shown in FIGS. 6A to 6D, the cam protrusion 22C begins to engage with the cam step portion 62C, and the disc receiver 22 begins to rise along the guide pins 58.

Then, as shown in FIG. 8, the abutment portion 75 abuts against the abutment portion 65, and the side surface of the inner periphery receiving portion 76 abuts against the side surface of the inner periphery receiving portion 66, whereby the recording/playback head-use window portion 20B is closed, and the cutout portion 62A is closed by the disc receiver 22.

At this time, the engagement protrusion 68 is smoothly inserted inside the concave portion 54 (see FIG. 3) due to the inclined surface of the concave portion 54, and the inner rotor 16 falls to a predetermined height. In other words, the outer peripheral edge portion of the disc medium 12 is supported by the outer periphery receiving portion 64 and the lower wall 22B of the disc receiver 22, and the chucking area 12C is supported by the inner periphery receiving portions 66 and 76. Thus, the recording surface 12B is again shielded from the outside, dust or the like is prevented from adhering to the recording surface 12B, and the disc cartridge 10 is discharged through the loading port of the drive device.

The above is the action when the disc medium 12 is loaded into the drive device together with the disc cartridge 10, but depending on the drive device, there are also instances where only the disc medium 12 is loaded into the drive device. In this instance, the disc medium 12 is removed from the disc cartridge 10. In other words, the user rotates the disc holder 24 towards the rear of the case 14 and completely opens the disc open portion 35.

At this time, as shown in FIG. 7C, when the disc holder 24 is rotated until the outer surface (upper surface) of the arm portion 82 of the disc holder 24 abuts against the rear edge portion of the cutout portion 30A, the position (maximum rotation position) of the disc holder 24 is temporarily retained.

Namely, when the disc holder 24 is rotated as far as the maximum rotation position, the coil spring 90, one end (hook 90A) of which is attached to the lock pin 38 and the other end (hook 90B) of which is attached to the lock pin 88, enters the widely formed cutout portion 30B in accompaniment with the rotation of the disc holder 24 and crosses the shaft portion 86 from below to above, and the urging force of the coil spring 90 works in the direction of arrow F.

Thus, the disc holder 24 is temporarily retainable at its maximum rotation position (removal position of the disc medium 12), whereby the disc medium 12 can be easily removed through the disc open portion 35.

When the disc medium 12 is to be again housed inside the case 14, the disc medium 12 is inserted in the disc open portion 35, and the disc holder 24 is rotated towards the front of the case 14. At this time, the disc holder 24 can be easily rotated by lightly pushing the disc holder 24 towards the front of the case 14.

In other words, because the coil spring 90 easily crosses the shaft portion 86 from above to below simply by lightly pushing the disc holder 24, the urging force of the coil spring 90 soon works to urge the disc holder 24 towards the disc medium 12. Thus, it becomes easy for the disc holder 24 to again retain the disc medium 12, whereby escape of the disc medium 12 from the disc open portion 35 and rattling of the disc medium 12 inside the housing portion 57 are again prevented.

Next, an example of the identification means of the disc cartridge pertaining to the present embodiment will be described.

As shown in FIG. 1, the ID labels 92 and 94, in which ID numbers including information such as the manufacturing history are described (ID marks), are adhered to the disc medium 12 and the case 14, and the ID number of the disc medium 12 and the ID number of the case 14 are made to match each other. Thus, the disc medium 12 and the case 14 can be made to correspond to each other on a one-to-one basis.

There are instances where, when the disc medium 12 is recordable, a user (a professional or heavy user) owning a specific recording device records information to the disc medium 12 in a state where the disc medium 12 is housed in the case 14, and a common user owning a simple playback device plays back the information recorded on the disc medium 12.

When the user using the disc medium 12 changes in this manner, it is preferable for the disc medium 12 to be handled in a state where the disc medium 12 is housed inside the case 14; however, because the specifications are also slightly different depending on the case 14, it is also conceivable for quality maintenance to be compromised, such as the recording/playback history of the disc medium 12 being lost, when the disc medium 12 is housed and handled in a case 14 other than the case 14 in which the disc medium 12 had been housed.

For this reason, by configuring the disc cartridge 10 so that it can be determined whether or not the disc medium 12 and the case 14 correspond to each other, the disc medium 12 can be housed inside the case 14 corresponding to the disc medium 12, without mistakenly housing the temporarily removed disk medium 12 inside a different case 14. Thus, when handling the disc medium 12 housed inside the case 14, the quality of the recording/playback history of the disc medium 12 can be maintained.

Here, ID numbers are used as identification means, and the same numbers are used for the disc medium 12 and the case 14. Thus, the disc medium 12 and the case 14 can be made to correspond to each other. Even when the disc medium 12 and the case 14 do not correspond to each other, this can soon be visually determined.

Also, the non-recording surface 12D of the disc medium 12 is the so-called printing surface side, and is the top surface of the disc medium 12. For this reason, by adhering the ID label 92 to the non-recording surface 12D side of the disc medium 12 and adhering the label 94 to the upper surface of the top plate 30 of the upper shell 26, whether or not the disc medium 12 and the case 14 correspond to each other can be easily confirmed when the disc medium 12 is to be housed inside the case 14 or when the disc medium 12 is already housed inside the case 14.

In the above embodiment, as the identification means, ID numbers were written in the ID labels 92 and 94 and the same numbers were used for the disc medium 12 and the case 14 so that the disc medium 12 and the case 14 corresponded to each other on a one-to-one basis, but the invention is not limited to this because it suffices as long as it can be determined whether or not the disc medium 12 and the case 14 correspond to each other. Instead of the ID numbers, it is also conceivable to use symbols, barcodes, characters, or any combination of these.

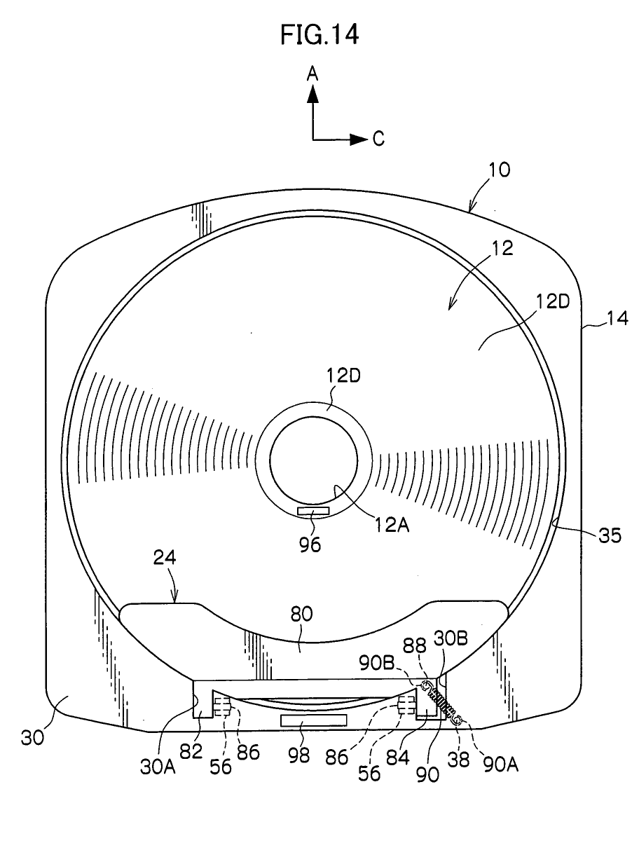

Instead of the ID labels 92 and 94, semiconductor memories 96 and 98 that are readable from the outside may be attached to the disc medium 12 and the case 14, as shown in FIG. 14. Data identifying the disc medium 12 or the case 14 are stored in advance in the semiconductor memories 96 and 98.

By using the semiconductor memories 96 and 98 in this manner, information can be stored even when the amount of information, such as the manufacturing history, of the disc medium 12 or the case 14 is large. Also, at the time of operation when the case 14 housing the disc medium 12 is inserted in the drive device, it can be automatically determined whether or not the disc medium 12 and the case 14 correspond to each other.

Also, although the ID labels 92 and 94 were respectively adhered to the non-recording surface 12D side of the disc medium 12 and the upper surface of the top plate 30 of the upper shell 26, the ID labels 92 and 94 are not limited to these positions because it suffices as long as whether or not the disc medium 12 and the case 14 match can be confirmed. Particularly when the identification means automatically determines this using the semiconductor memories 96 and 98, the semiconductor memories 96 and 98 may be attached at positions that are not visible. The semiconductor memories may be RFIDs or IC tags.

Here, the invention was configured so that the differently shaped shutter member 18 and the inner rotor 16 were moved in mutually different directions to open the recording/playback head-use window portion 20B, but the shapes of the shutter member and inner rotor and the drive mechanism are not limited to this embodiment. For example, the invention may also be configured so that the inner rotor is made to support a pair of shutter members that move in parallel in accompaniment with the rotation of the inner rotor to open and close the opening.

In the above embodiment, a configuration was described where the diameter of the disc medium 12 was substantially 120 mm, but the invention is not limited to this. The invention is applicable to disc cartridges 10 disposed with disc media 12 of any dimension.

In the disc cartridge of the invention, the identification means may include ID marks disposed on the disc medium and the case.

In this instance, by disposing ID marks on the disc medium and the case, it can be identified whether or not the disc medium and the case match. For example, the ID marks may be numbers that include information such as the manufacturing history and are the same between the disc medium and the case, so that the disc medium and the case can be corresponded to each other by writing these numbers on the disc medium and the case, and so that even when the disc medium and the case do not correspond to each other, this can soon be determined.

In the disc cartridge of the invention, the ID marks may be visibly printed on the disc medium and the case.

In this instance, the ID marks may be visibly printed on the printing surface or non-recording surface of the disc medium and the upper surface, lower surface or side surface of the case, so that whether or not the disc medium and the case correspond to each other can be visually and easily determined.

In the disc cartridge of the invention, the ID marks may be disposed on the printing surface of the disc medium and the upper surface of the case.

In this instance, by disposing the ID marks on the printing surface of the disc medium and the upper surface of the case, it can be determined whether or not the disc medium and the case correspond to each other when the disc medium is to be housed inside the case or when the disc medium is already housed inside the case.

In the disc cartridge of the invention, the identification means may include semiconductor memories that are disposed on the disc medium and the case and are readable from the outside.

In this invention, by disposing semiconductor memories that readable from the outside on the disc medium and the case, information can be stored even when the amount of information resulting from the manufacturing history of the disk medium or the case is large. Also, when the case housing the disc medium is inserted in the drive device, it can be automatically determined whether or not the disc medium and the case correspond to each other.

In the disc cartridge of the invention, the case may be configured by an upper shell and a lower shell, and the disc cartridge may further include: a head open portion that is disposed in the lower shell and is configured to allow a recording/playback head of the drive device to access the disc medium; a shutter mechanism where a first shutter disposed inside the case coaxially with the disc medium and a second shutter that is rotatable around an axis different from that of the first shutter rotate in opposite directions in mutual cooperation to open and close the head open portion; a disc open portion that is formed in the upper shell and into and from which the disc medium can be put and taken out; and a holding member that is axially supported at the upper shell and pushes the disc medium towards the first shutter through the disc open portion.

In this invention, the case may be configured by the upper shell and the lower shell, and the head open portion may be disposed in the lower shell and configured to allow the recording/playback head of the drive device to access the disc medium. Also, the shutter mechanism is configured by the first shutter disposed inside the case coaxially with the disc medium and the second shutter that is rotatable around an axis different from that of the first shutter rotate, with the first shutter and the second shutter rotating in opposite directions in mutual cooperation to open and close the head open portion.

The disc open portion into and from which the disc medium can be put and taken out is formed in the upper shell, and the holding member is axially supported at the upper shell and configured to push the disc medium towards the first shutter through the disc open portion.

Thus, while the disc cartridge is being loaded into the drive device, the recording/playback head of the drive device can access the disc medium inside the cartridge, and the state where the disc medium is stored in a closed space shielded from the outside can be maintained in the drive device. Thus, the potential for dust from the outside to adhere to the recording surface (undersurface side) of the disc medium and impair the recording or playback of information is reduced.

In the present invention, by disposing identification means with which it is possible to identify to determine whether or not the disc medium and the case correspond to each other, the disc medium can be housed inside the case corresponding to that disc medium, without mistakenly housing the temporarily removed disk medium inside a different case. Thus, the quality of the recording/playback history of the disc medium housed inside the case can be maintained.

The invention may be configured so that the identification of the match between the disc medium and the case is improved by disposing ID marks on the disc medium and the case.

The invention may be configured so that whether or not the disc medium and the case correspond to each other can be visually and easily determined.

The invention may be configured so that it can be determined whether or not the disc medium and the case correspond to each other when the disc medium is to be housed inside the case or when the disc medium is already housed inside the case.

The invention may be configured so that information can be stored using semiconductor memories even when the amount of information resulting from the manufacturing history of the disk medium or the case is large. In this instance, for example, when the case housing the disc medium is inserted in the drive device, it can be automatically determined whether or not the disc medium and the case correspond to each other.

In this invention, while the disc cartridge is being loaded into the drive device, the recording/playback head of the drive device can access the disc medium inside the cartridge, and the state where the disc medium is stored in a closed space shielded from the outside can be maintained in the drive device. Thus, the potential for dust from the outside to adhere to the recording surface (undersurface side) of the disc medium and impair the recording or playback of information is reduced.

1. A disc cartridge comprising:
a disc medium that is loaded into a drive device and to and from which information can be recorded and played back;
a case that rotatably houses the disc medium and into and from which the disc medium can be put and taken out; and
identification means for determining whether or not the disc medium and the case correspond to each other.

2. The disc cartridge of claim 1, wherein the identification means includes ID marks disposed on the disc medium and the case.

3. The disc cartridge of claim 2, wherein the ID marks include being visibly printed on the disc medium and the case.

4. The disc cartridge of claim 3, wherein the ID marks are disposed on a printing surface of the disc medium and an upper surface of the case.

5. The disc cartridge of claim 1, wherein the identification means includes semiconductor memories that are disposed on the disc medium and the case and are readable from the outside.

6. The disc cartridge of claim 1, wherein
the case is configured by an upper shell and a lower shell, and
the disc cartridge further comprises
a head open portion that is disposed in the lower shell and is configured to allow a recording/playback head of the drive device to access the disc medium,
a shutter mechanism where a first shutter disposed inside the case coaxially with the disc medium and a second shutter that is rotatable around an axis different from that of the first shutter rotate in opposite directions in mutual cooperation to open and close the head open portion,
a disc open portion that is formed in the upper shell and into and from which the disc medium can be put and taken out, and
a holding member that is axially supported at the upper shell and pushes the disc medium towards the first shutter through the disc open portion.

7. A disc cartridge comprising:
a disc medium that is loaded into a drive device and to and from which information can be recorded and played back;
a case that rotatably houses the disc medium and into and from which the disc medium can be put and taken out; and
an identification device that determines whether or not the disc medium and the case correspond to each other.

8. The disc cartridge of claim 7, wherein the identification portion displays identification data unique to the disc medium and the case.

9. The disc cartridge of claim 7, wherein the identification device is disposed with semiconductor memories that can record plural types of identification data unique to the disc medium and the case.

10. The disc cartridge of claim 8, wherein the displayed identification data includes numbers.

11. The disc cartridge of claim 8, wherein the displayed identification data includes symbols.

12. The disc cartridge of claim 8, wherein the displayed identification data includes bar codes.

13. The disc cartridge of claim 8, wherein the displayed identification data includes characters.

14. The disc cartridge of claim 9, wherein the semiconductor memories configure RFID memories.
